(19) United States
(12) Patent Application Publication
(10) Pub. No.: US 2006/0242181 A1
(43) Pub. Date: Oct. 26, 2006

(54) Apparatus and method for transforming XBRL data into database schema

(75) Inventor: Diane Carol Mueller-Klingspor, Vancouver (CA)

Correspondence Address: COOLEY GODWARD, LLP, 3000 EL CAMINO REAL, 5 PALO ALTO SQUARE, PALO ALTO, CA, 94306, US

(73) Assignee: Business Objects, S.A. Levallois-Perret (FR)

(21) Appl. No.: 11/112,752

(22) Filed: Apr. 22, 2005

(51) Int. Cl. G06F 7/00

(52) U.S. Cl. 707/101

(57) ABSTRACT

A computer readable medium includes executable instructions to extract XBRL data from a web service feed data source and construct an optimized database schema and tables, based on maintaining the integrity of the XBRL metadata. The XBRL data can then be loaded into the database, and refreshed, such that the XBRL data is assessed and the database schema and tables are updated as required.

### CROSS-REFERENCE TO RELATED APPLICATION

This application is related to the following concurrently filed, commonly owned patent application, which is incorporated by reference herein: Apparatus and Method for Constructing a Semantic Layer Based on XBRL Data, Ser. No. ______, filed Apr. 22, 2005.

### BRIEF DESCRIPTION OF THE INVENTION

This invention relates generally to processing digital data. More particularly, this invention relates to transforming eXtensible Business Reporting Language (XBRL) data into a database schema to facilitate Business Intelligence data processing.

### BACKGROUND OF THE INVENTION

Business Intelligence generally refers to software tools used to improve business enterprise decision-making. More specifically, these tools can include: reporting and analysis tools to present information; content delivery infrastructure systems for delivery and management of reports and analytics; data warehousing systems for cleansing and consolidating information from disparate sources; and, data management systems, such as relational databases used to collect, store, and manage raw data.

The ability to work with various data sources is a key aspect of Business Intelligence tools. A business often collects information from internal and external sources where the information is stored in different formats and structures. Regardless of the initial format and structure of the data, a business wants to be able to work with the data and combine the different data sources together in consistent structures that enable the data from different sources to be brought together and used in consistent ways. In the process of consolidating the information, a business does not want to lose significant information contained within the original data source.

EXtensible Business Reporting Language (XBRL) is an XML (extensible Markup Language) based specification developed specifically for preparing, publishing, and analyzing the financial information of an enterprise. The financial information specified by XBRL includes such data as annual and quarterly reports, SEC filings, general ledger information, net revenue and accountancy schedules. XBRL has metadata within a Discoverable Taxonomy Set (DTS) and a document instance. Within the DTS, overarching structures and metadata within linkbases (such as formulas, calculations, presentation, and relationships within the data) are defined. Within the document instance, there are specific structures, such as tuples, and context information (including durations and units of measure) for the data. This structural information and metadata in both the DTS and document instance needs to be maintained in order to avoid stripping meaning from the data.

Ideally, a Business Intelligence tool should be able to work with XBRL in a way that is consistent with other data without losing the information found in the XBRL structures and metadata. To design Business Intelligence tools to work directly with the data in the XBRL format without losing the XBRL metadata is inefficient as XBRL does not provide an optimized data structure for Business Intelligence and is not an efficient medium for storing a large volume of data that can be efficiently queried and retrieved. In order to maintain the structural logic and metadata found in XBRL, a process and tool for the mapping of XBRL metadata constructs to database schemas is required. Then the XBRL data can be mapped into the XBRL enhanced database schemas and accessed by Business Intelligence tools without the loss of the integrity of the metadata in the original XBRL.

### SUMMARY OF THE INVENTION

The invention includes a computer readable medium with executable instructions to receive extensible Business Reporting Language (XBRL) data and associated metadata. The XBRL data and associated metadata is mapped into a database schema. The XBRL data and associated metadata is then loaded into the database schema.

The invention includes a computer readable medium with executable instructions to accept an XBRL web service feed as a data source and create a relational database schema and tables that are optimized to maintain the integrity of the XBRL metadata and structures. Once the schema has been constructed, it can be loaded with data from an XBRL data source. Using scheduling tools, the data in the database can be updated on-demand or at regularly scheduled intervals. When the data in the database is updated (e.g., based on the XBRL data source feed), an assessment occurs to determine if the database schema or tables need to be extended to accommodate new structures in the incoming XBRL. The structure of the incoming XBRL is compared to the database schema and tables to determine whether the database schema or tables need to be extended.

The invention makes use of existing Extraction, Transformation, Loading (ETL) tools in order to extract data, map data, extend schema, load data, and schedule data. This set of tools, referred to as the ETL platform throughout the disclosure includes optional web service adapter(s), data extraction tools, mapping tools, loading tools, and scheduling tools. The ETL process is not in itself unknown, as it already exists in such products as Business. Objects Data Integrator, sold by Business Objects Americas, San Jose, Calif. The innovation includes the specific strategies and logic for handling XBRL and maintaining the integrity of the metadata.

The invention also includes a computer readable medium storing executable instructions to construct the database for the XBRL document instance and DTS. The executable instructions include executable instructions to interpret XBRL that is supplied as a web service data source and assess whether there is an existing database into which the data can be loaded, and to construct the database if it does not exist, or modify the database if the metadata in the XBRL changes and requires schema or table changes. The database is constructed in such a way that the integrity of the metadata within the document instance and DTS is maintained and optimized. If the schema and table structure do not require modifications, the data is loaded within the database. The user is allowed to schedule updates to the database or run the process on-demand.

This database can be saved to a computer readable medium and accessed by other users and other programs. The invention provides a set of logical relationships for defining the relationships and metadata within the XBRL and matching that to relationships within an optimized database structure that is designed to maintain these relationships. Advantageously, the invention enables users without a specific understanding of XBRL data structures or relational database design to access data based on an XBRL data source and to create reports and use other Business Intelligence tools against this data and the metadata contained within the XBRL without having specific technical skills or knowledge.

### BRIEF DESCRIPTION OF THE FIGURES

The invention is more fully appreciated in connection with the following detailed description taken in conjunction with the accompanying drawings, in which:

FIG. 1 illustrates the overall business context and the type of system within which the invention can be implemented.

FIG. 2 illustrates processing of XBRL source data in accordance with an embodiment of the invention.

FIG. 3 illustrates processing of XBRL source data in accordance with an embodiment of the invention.

FIG. 4 illustrates the relationship between an XBRL document instance and a discoverable taxonomy set (DTS), which is used to identify the XBRL logic and metadata that is maintained in constructed database schema and relational tables.

FIG. 5 illustrates an exemplary database structure that is designed to maintain XBRL metadata integrity in accordance with an embodiment off the invention.

FIG. 6 illustrates a general process used to construct a database schema and tables based on an XBRL data source.

Like reference numerals refer to corresponding parts throughout the several views of the drawings.

### DETAILED DESCRIPTION OF THE INVENTION

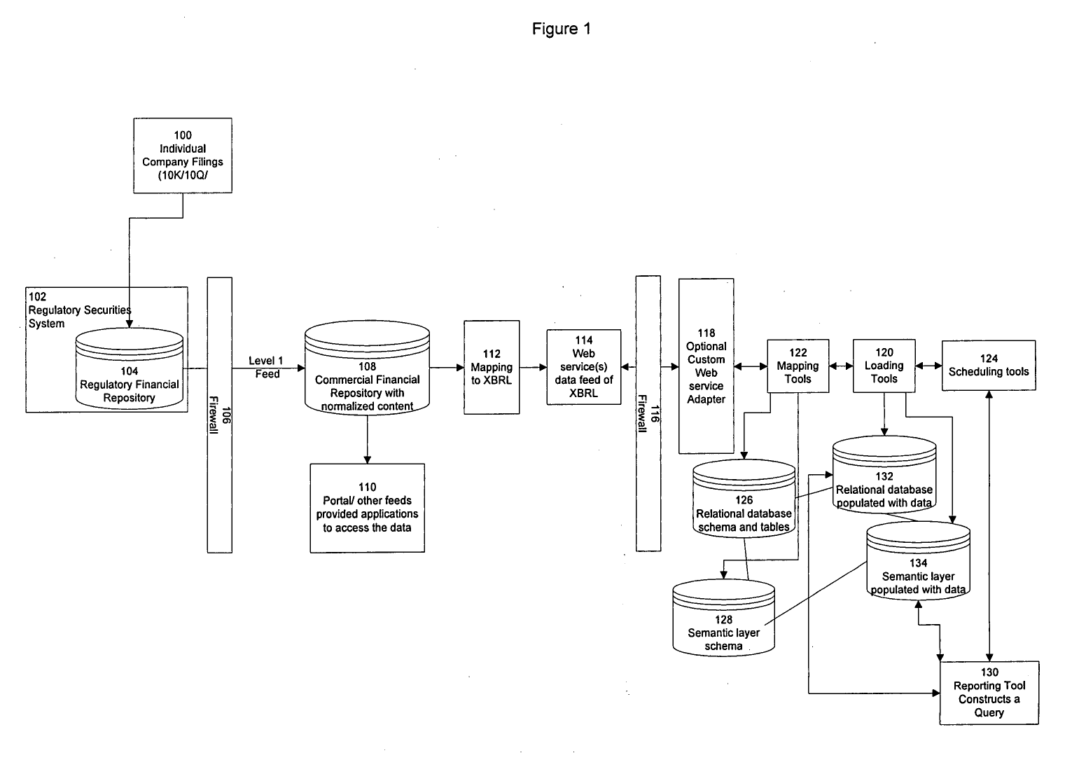

FIG. 1 illustrates an example of the overall business context and type of system within which the invention can be implemented. An individual company files a report 100 with a regulatory agency (e.g., the U.S. Securities and Exchange Commission) 102. This filing may be made electronically or through any other means. The regulatory body then stores this report within a repository 104. The regulatory body may need to scan this document and may normalize the report. The regulatory body provides a data feed service for its filings. Typically, subscribers to the data feed are external financial services that are outside the regulatory body's firewall 106. The commercial repository system 108 may normalize the content if it has not previously been normalized. An example of this sort of commercial financial repository is Edgar Online, which receives data from the U.S. Securities and Exchange Commission, normalizes the data and stores the data. Thereafter, the data is accessible, for example, via a web service based XBRL data source feed. This commercial financial repository may be accessible through any number of portals and applications 110.

The data within the commercial financial repository is mapped to XBRL 112. When a regulatory body provides the XBRL data source directly (e.g., via an XBRL web service provided by the regulatory body), components 108, 110, and 112 are not required. In this example, the web service(s) 114 are shown as being provided by a commercial financial repository, merely to illustrate one potential implementation. The web services 114 may contain more than one web service in order to accommodate information other than the XBRL data source, such as user identification and authentication. Typically, this web service is separated by a firewall 116.

The invention may be supported by any required web service adapters 118 that are specific to the web service data feed format that is being processed. The web service adapter can handle such issues as variance in standard/security levels, as well as any specific aspects specific to the provided web services, such as authentication. The invention works within an ETL framework, with Mapping Tools 122 that discover the schema based on the data source and extracts the metadata and structural information from the XBRL data source. Based on optimizations specific to the data structure discovered, a database schema and related tables are constructed 126. Optionally, a semantic layer schema 128 may also be constructed. At this point, the database and semantic layer are not populated with specific data. Loading tools 120 load the specific data within the database tables 132, and optionally load the semantic structure 134. In other words, the schema and tables 126 are now populated with the data from the XBRL data source to construct a database that contains the information from the XBRL data source 132 and that can be queried directly. Similarly, the semantic layer schema 128 is populated with the specific labels and fields 134 to construct a semantic layer that contains the specific metadata 134.

Scheduling Tools 124 are used to schedule when the data within the database 132 will be updated. Reporting tools 130 enable the user to construct a query, this query can then be applied against the database 132 or semantic layer 134 or can be run against the web service data feed using the scheduling tools 124. In addition to queries defined by users, queries can be defined and run or scheduled programmatically.

FIG. 1 illustrates three phases, the first being a collection phase, using components 100-106. The collection phase involves a regulatory body collecting data and providing a data feed service. The second phase is optional, involving a commercial financial service that provides a web service based XBRL data feed using components 108-116. The third phase is focused on Business Intelligence tools and the ability to work with and analyze data. This phase is implemented with components 118-134.

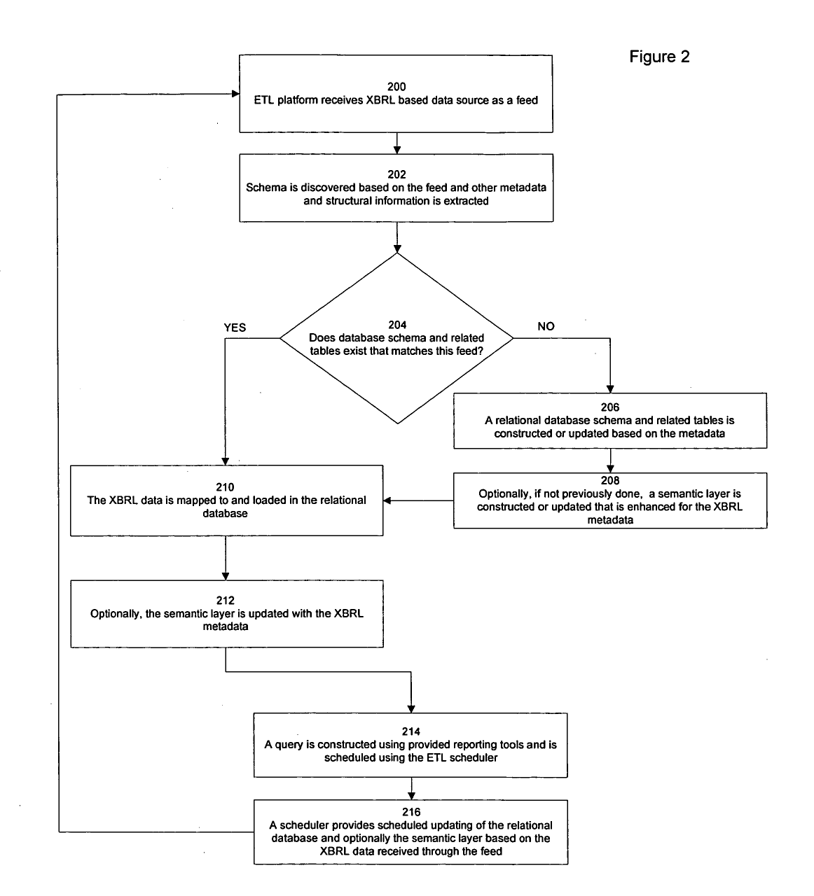

FIG. 2 illustrates one implementation of an Extraction, Transformation, Loading (ETL) process handling an XBRL data source. After the ETL platform receives the XBRL based data source 200, it discovers the schema based on the data source and other metadata and structural data 202. For example, executable instructions associated with mapping tools 122 may be used to implement this operation. The XBRL data source is then validated against any existing database structures and tables to confirm that there is a pre-existing database and that no updates or modifications to the schema or additional tables are required 204. If either the construction of a new database or modifications to an existing database are required, the database schema/tables are constructed or updated 206 and optionally the semantic layer is constructed or updated 208. Executable instructions associated with the mapping tools 122 may be used to implement these operations.

Once the database has been validated and it is confirmed that the database contains the appropriate structure and tables, the XBRL data is loaded into the database 210. Executable instructions associated with loading tools 120 may be used to implement this operation.

Optionally, the semantic layer is updated with the XBRL metadata 212. A query is then constructed using reporting tools 214. For example, executable instructions associated with the reporting tool 130 of FIG. 1 may be used to implement this operation. Executable instructions associated with the scheduling tools 124 may be used to launch a query in accordance with a specified schedule. The final operation associated with the process of FIG. 2 is to use a scheduler (e.g., scheduling tools 124) to update the relational database and optionally the semantic layer 216. A scheduled or on-demand query triggers the process 200 of receiving XBRL data and validating the data against the existing database/semantic layer structure.

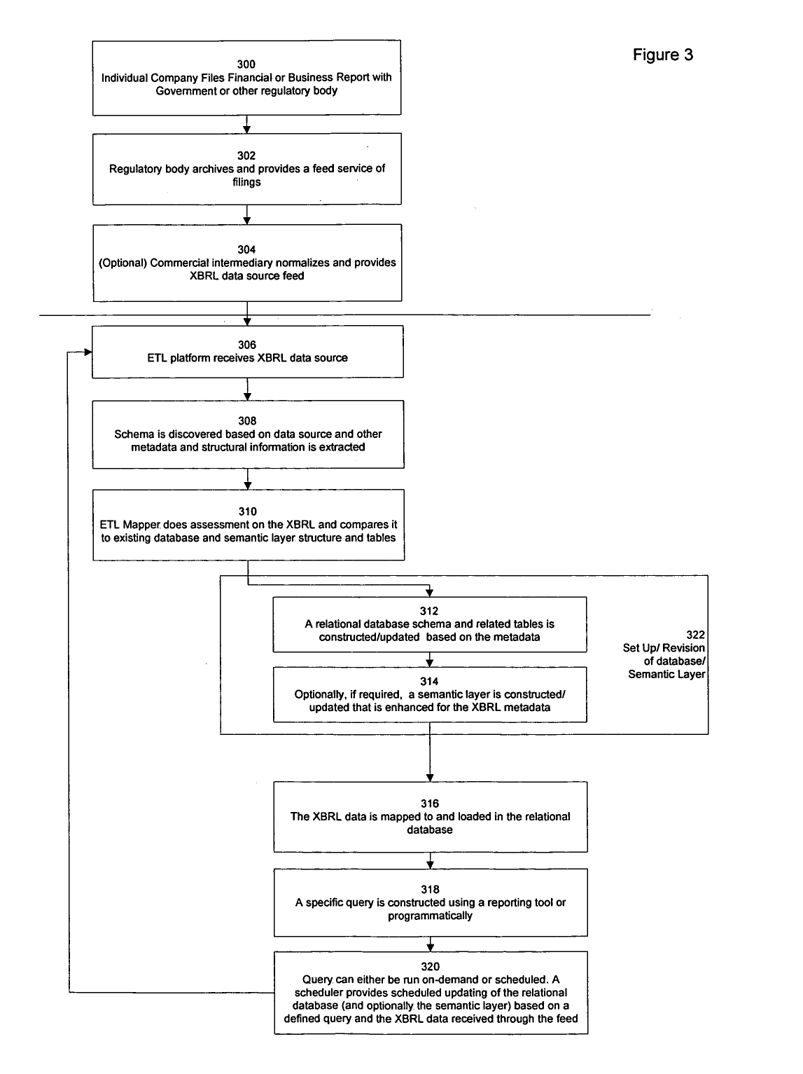

FIG. 3 illustrates processing associated with an embodiment of the invention. Currently, in many countries the government, or another regulatory body, collects financial reports from companies 300, archives those reports and provides data feed services 302, commercial intermediaries may normalize this data and provide it as an XBRL data source. In the case when the regulatory body itself provides an XBRL data feed, the invention can work directly with that data source rather than requiring a commercial intermediary 304 to provide the data source.

The ETL platform receives the XBRL based data source 306. As shown in FIG. 1, custom web service adapters or other interfaces may be required to access the XBRL data source. The schema (and other relevant metadata and structural information) is discovered based on the data source 308. The ETL mapper validates the data source against any existing database 310. If no database exists or modifications to the existing database are required, the database is constructed or updated 312 and optionally the semantic layer is constructed 314. Steps 312 and 314 are part of a Set Up/ Revision process 322 that occurs either the first time that a query is run or when the metadata in the XBRL data source has changed in such a way that the database should reflect the change in order to provide an optimized schema and the appropriate tables. Generally, when a query is run, an assessment 310 indicates whether an alteration is required and the data is mapped and loaded within the existing relational database 316. Queries are constructed either programmatically or using a reporting tool with a graphical user interface (GUI). Queries can be executed programmatically or using the reporting tools 318. When a query is executed on demand or scheduled 320, the process begins with the ETL platform receiving the XBRL based data source 306. The query can also be run against the static data within the database, if there is no need to refresh the data from the XBRL data source.

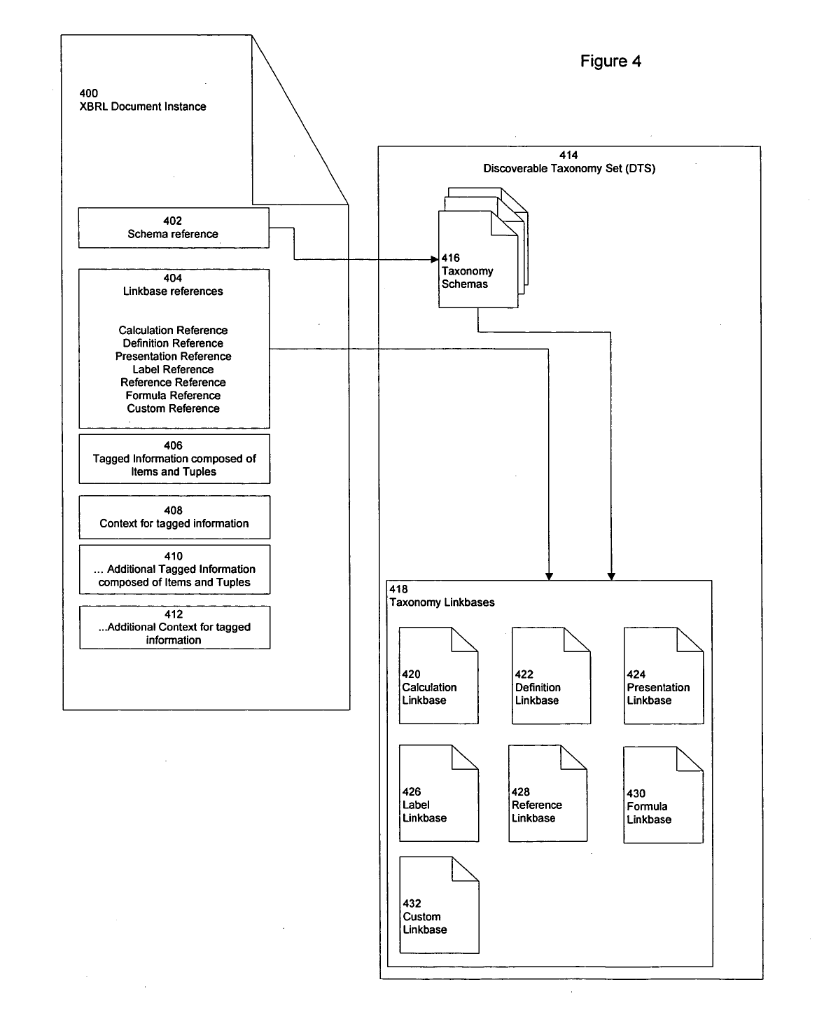

FIG. 4 illustrates the relationship between an XBRL document instance 400 and a discoverable taxonomy set (DTS) 414. The XBRL document instance 400 is the “XML” (Extensible Markup Language) file that contains the data and also identifies the schema and taxonomy linkbases that the document instance depends on for its complete meaning. The schema 402 and link base references 404 generally point to resources available on the internet, but they can also refer to other files provided as accompanying physical files or by other means. Below is an example of how the document instance references a schema 416 and linkbase 418 located on the internet:

<schema targetNamespace=”http://www.xbrl.org/2003/instance”
xmlns=″http://www.w3.org/2001/XMLSchema″
xmlns:xbrli=″http://www.xbrl.org/2003/instance″
xmlns:link=″http://www.xbrl.org/2003/linkbase″
elementFormDefault=″qualified″>

In addition to referencing external documents, the XBRL document instance also contains meaning within its own structure. As sections 406 and 410 illustrate, the data contains discrete items, as well as tuples (collections of data items and potentially additional tuples related to the same overall fact). In addition to the data, there is also explanatory context information for the data 408 and 412. The context information provides information that makes the data itself more meaningful. For example, in the following xml, two values “2584000” and “2077000” constitute a tuple that relates to “ifrs-gp:AssetsTotal.” Both values have context references that provide metadata that explains each value:

<ifrs-gp:AssetsTotal contextRef=“Current_AsOf”
unitRef=“U-Euros”>

2584000</ifrs-gp:AssetsTotal>

<ifrs-gp:AssetsTotal contextRef=“Prior_AsOf”
unitRef=“U-Euros”> 2077000</ifrs-

gp:AssetsTotal>

For each value, context information for a period and unit is provided. These contexts are defined elsewhere within the document instance. For example, in this case the period “Prior-AsOf” is defined:

<context id=“Prior_AsOf”>
<entity>
<identifier scheme=“http://www.sampleCompany.com”>Sample
Company</identifier>
</entity>
<period>
<instant>2004-12-31</instant>
</period>
</context>

Similarly the context information for the unit is specified:

<unit id=“U-Euros”>
<measure>iso4217:EUR</measure>
</unit>

The invention maintains the relationship of the two items for “ifrs-gp:AssetsTotal” and the contextual information for the items when constructing database schemas and tables.

In addition to the metadata located within the document instance 400, the DTS 414 provides another layer of metadata. A number of taxonomy schemas and linkbases can be associated with the document instance and these schemas and linkbases provide additional XBRL metadata. The taxonomy schemas contain additional metadata concerning the acceptable relationships between the data items and how they are structured. The linkbases are typically classified within three categories of metadata: label links, reference links, and relation links. Label links are defined in the label linkbase 426 and typically define a standard label for a business concept (using the label element), a locator for the business concept (using the loc element), and a link (or arc), connecting the business concept to the label (using the labelArc element).

Reference links are defined in the reference linkbase 428. Typically, reference links associate references to authoritative background or definition information in the business domain. The reference mechanism used is similar to the label links in that a reference link is defined with a locator for the business concept, one or more references to documentation, and a referenceArc defining the association between the locator and the reference(s). Relation links are defined in linkbases such as: calculation linkbase 420, definition linkbase 422, presentation linkbase 424, and formula linkbase 430.

In contrast to label and reference links that relate business concepts to metadata, relation links relate business concepts to other business concepts. For example, calculation links define how a given concept figures in the calculation of another business concept. For example, the concept “profitAfterTax” is calculated from the concepts “profitBeforeTax” and “taxPaid” by subtracting one from the other. For example, profitAfterTax can be represented by the following formula:
profitAfterTax=weight(1)*profitBeforeTax+weight(−1)*taxPaid

The relationship between these three business concepts is captured in the calculationLink in the following:

<calculationArc

xlink:type= “arc”
xlink: arcrole= http://www.xbrl.org/2003role#summation-item\

xlink:from= “profitAfterTax”

xlink:to= “profitBeforeTax”
weight= “1.0”
order = “1” />

<calculationArc

xlink:type= “arc”
xlink: arcrole= http://www.xbrl.org/2003role#summation-item\

xlink:from= “profitAfterTax”

xlink:to= “taxPaid”
weight= “1.0”
order = “2” />

Definition links describe several types of relationships among business concepts, such as generalization-specialization relationships (e.g., “postalCode” is a generalization of “zipCode”) and other relationships between business concepts.

Presentation links, as the name implies, define the relationships between concepts from a presentation perspective (e.g., in the presentation of the report, a parent/child relationship should be shown between “sales” and “telephoneSales”). In addition to the standard linkbases, additional custom linkbases 432 can be defined to extend the logic of the existing linkbases.

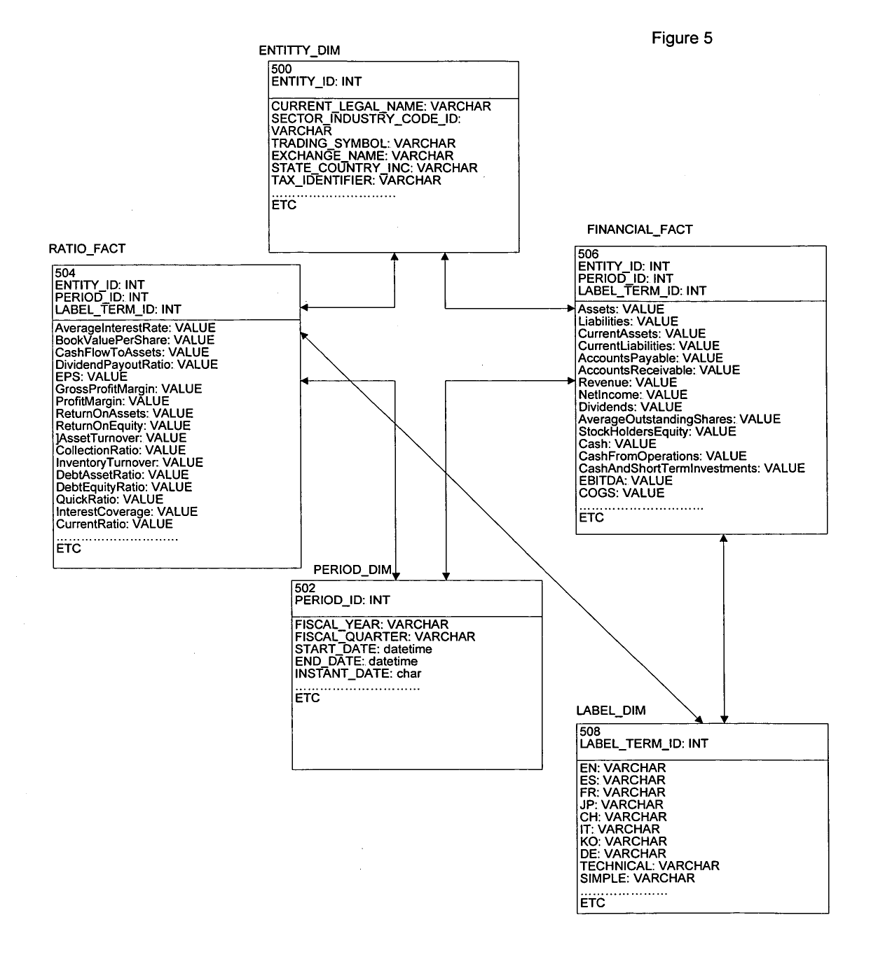

FIG. 5 illustrates a potential database structure designed to maintain XBRL metadata integrity. In the schema, the Entity 500, Period 502 and Label 508 dimensions are joined to fact tables that reflect the XBRL content. In this case, the fact tables are defined as Financial 506 and Ratio 504 fact tables. These specific tables are provided for illustrative purposes and there may be additional fact tables to reflect the content of the XBRL data source. The fields for the entity are defined within the taxonomy schemas illustrated as 416 within the discoverable taxonomy set (DTS) 414. The period dimension 502 is defined in the DTS, but is also associated with specific elements within the document instance. This contextual relationship is maintained through the joins within the database schema.

The label dimension 508 is based on a linkbase that provides alternative language labels of elements within the XBRL data source and the resulting database. These labels may be for different languages or for different terminology sets (such as simple or technical versions of the labels).

The fact tables 504, 506 provide a framework for the specific data items from the document instance and additional calculated values based on those data items. In this example, the financial fact table 506 contains data items that may be based on simple formulas or may be defined directly, while the ratio fact table 504 contains elements that are based on business formulas and are generally calculated based on values from the financial fact table 506. The ratio fact table 504, and any other similar table built based on the financial fact table 506, provides optimizations by pre-building standard calculations that are defined within the DTS. In this way, end users are able to view and use pre-calculated values and are not required to define these calculations and formulas within reports. Additional fact tables may be incorporated in the schema in order to accommodate other values associated with the entity or period dimensions.

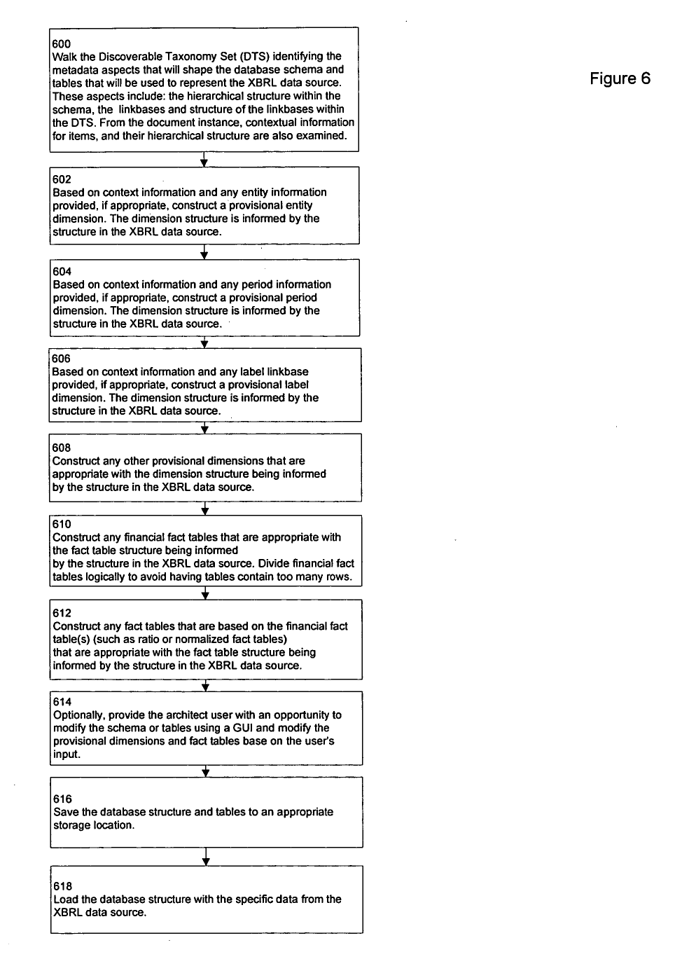

FIG. 5 provides a simple example of a potential schema. In order to accommodate more complex data, root dimensions and more complex structures are implemented. FIG. 6 illustrates a process to construct a database schema and tables based on an XBRL data source. First, the DTS is scanned in order to identify the metadata aspects that will shape the database schema and tables 600. The document instance is also examined. The types of aspects that are considered include: the hierarchical structure within the document instance as well as within the schema(s), the contextual information for items within the document instance, and linkbases and the structures of linkbases. Based on the context information and any other relevant information that is identified when the DTS is scanned, a provisional entity dimension is constructed 602, if appropriate. Similarly, based on the period information that is identified, a provisional period dimension is constructed 604, if appropriate. Similarly, based on the label information, particularly a label linkbase, a provisional label dimension is constructed 606, if appropriate. Any other dimensions represented in the XBRL data source are also constructed as provisional dimensions 608. The provisional dimensions are determined based on the relationships between data elements and the hierarchical structure of the schemas and document instances. Root dimension tables may be constructed with child dimension tables in order maintain the hierarchy and complexity of the data within the XBRL data source. A provisional entity and period dimension are typically constructed. Specific structural aspects of the schema are provided for the purpose of illustration and should not be seen as limiting or restricting the schema and tables that the invention can utilize.

After the dimensions have been defined, fact tables based on the dimensions are defined. First, provisional financial fact tables(s) are defined 610. Depending on the size of the financial fact table, the financial fact table(s) 610 are logically divided for performance reasons. Additional fact tables 612 based on the logic of the initial financial fact table(s) provide optimizations by pre-building standard calculations that are defined within the DTS. In this way, end users are able to view and use these pre-calculated values without needing to specify, or have specified for them, the definition for these calculations and formulas.

Optionally, a user views the provisional schema and table structures using a GUI. The user may modify the provisional dimensions and fact tables that characterize the data source 614. The database structure and tables are then stored in an appropriate storage location 616. Then the database is loaded with the specific data from the XBRL data source 618.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium comprising executable instructions to:
receive eXtensible Business Reporting Language (XBRL) data and associated metadata;
map said XBRL data and associated metadata into a database schema; and
load said XBRL data and associated metadata into said database schema.

2. The computer readable medium of claim 1 wherein said executable instructions to map include executable instructions to map said XBRL data and associated metadata into a relational database schema.

3. The computer readable medium of claim 2 wherein said executable instructions to map include executable instructions to map said XBRL data and associated metadata to relational database dimension and fact tables.

4. The computer readable medium of claim 3 wherein said executable instructions to map include executable instructions to map said XBRL data and associated metadata to relational database dimension and fact tables with joins and contexts.

5. The computer readable medium of claim 1 wherein said executable instructions to map include executable instructions to validate whether a database exists with required schema, and if not, construct required schema corresponding to said XBRL data and associated metadata.

6. The computer readable medium of claim 5 further comprising executable instructions to supply recommended schema to a user.

7. The computer readable medium of claim 6 further comprising executable instructions to allow alterations to recommended schema.

8. The computer readable medium of claim 1 wherein said executable instructions to receive include executable instructions to receive from a commercial XBRL data source.

9. A computer readable medium comprising executable instructions to:
receive data with a discoverable taxonomy and linkbase; and
map said data into a database schema; and
load said data into said database schema.

10. The computer readable medium of claim 9 wherein said executable instructions to map include executable instructions to map said discoverable taxonomy into a relational database schema.

11. The computer readable medium of claim 10 wherein said executable instructions to map include executable instructions to map said discoverable taxonomy into relational database dimension and fact tables.

12. The computer readable medium of claim 11 wherein said executable instructions to map include executable instructions to map said discoverable taxonomy to relational database dimension and fact tables with joins and contexts.

13. The computer readable medium of claim 9 wherein said executable instructions to map include executable instructions to validate whether a database exists with required schema, and if not, construct required schema corresponding to said discoverable taxonomy.

14. The computer readable medium of claim 13 further comprising executable instructions to supply recommended schema to a user.

15. The computer readable medium of claim 14 further comprising executable instructions to allow alterations to recommended schema.

16. The computer readable medium of claim 9 wherein said executable instructions to receive include executable instructions to receive from a commercial XBRL data source.

17. The computer readable medium of claim 9 further comprising executable instructions to query said database schema.

18. The computer readable medium of claim 17 wherein said executable instructions to query include executable instructions to query said database using a reporting tool.

19. The computer readable medium of claim 17 wherein said executable instructions to query said database include executable instructions to automatically query said database.

20. The computer readable medium of claim 19 wherein said executable instructions to query said database include executable instructions to automatically query said database in accordance with a specified schedule.
